(19) United States
(12) Patent Application Publication
(10) Pub. No.: US 2016/0121270 A1
(43) Pub. Date: May 5, 2016

(54) FILTRATION APPARATUS AND IMMERSION-TYPE FILTRATION METHOD USING THE APPARATUS

(71) Applicant: SUMITOMO ELECTRIC INDUSTRIES, LTD., Osaka-shi, Osaka (JP)

(72) Inventors: Hiromu TANAKA, Osaka (JP); Toru MORITA, Osaka (JP)

(73) Assignee: SUMITOMO ELECTRIC INDUSTRIES, LTD., Osaka-shi, Osaka (JP)

(21) Appl. No.: 14/893,600

(22) PCT Filed: Apr. 9, 2014
(86) PCT No.: PCT/JP2014/060295

§ 371 Date: Nov. 24, 2015

(30) Foreign Application Priority Data
May 30, 2013 (JP) 2013-114568
Dec. 26, 2013 (JP) 2013-270472

(51) Int. Cl. B01D 65/02; B01D 63/04

(52) U.S. Cl. CPC B01D 65/02; B01D 63/04; B01D 2313/26; B01D 2315/06; B01D 2321/185

(57) ABSTRACT

The invention offers a filtration apparatus having excellent capability to clean the surface of hollow-fiber membranes and being able to maintain high filtration capability and an immersion-type filtration method using the filtration apparatus. The invention is a filtration apparatus that is an immersion type and that is provided with both a filtration module having multiple hollow-fiber membranes held in a state in which they are arranged by being pulled unidirectionally and a gas supplier that supplies gas bubbles from under the filtration module. In the filtration apparatus, each of the gas bubbles supplied by the gas supplier is divided into a plurality of gas bubbles after colliding against the filtration module. It is desirable that the gas bubbles supplied by the gas supplier have an average horizontal diameter larger than the maximum spacing of holding portions in the multiple hollow-fiber membranes in the filtration module.

### TECHNICAL FIELD

The present invention relates to a filtration apparatus and an immersion-type filtration method using the filtration apparatus.

### BACKGROUND ART

As a solid-liquid separation treatment apparatus used for sewage treatment and in the manufacturing process of pharmaceuticals and others, a filtration apparatus is used that incorporates a filtration module in which a plurality of hollow-fiber membranes are bundled. The types of the filtration module includes the following three types: an external-pressure type in which a treatment-undergoing liquid is permeated into the inner-circumferential side of the hollow-fiber membranes by applying high pressure to the outer-circumferential side of them; an immersion type in which a treatment-undergoing liquid is permeated into the inner-circumferential side by the force of osmotic pressure or of negative pressure at the inner-circumferential side; and an internal-pressure type in which a treatment-undergoing liquid is permeated to the outer-circumferential side of the hollow-fiber membranes by applying high pressure to the inner-circumferential side of them.

Of the foregoing filtration modules, the external-pressure type and the immersion type have a drawback in that as the use is repeated, the surface of the individual hollow-fiber membranes is contaminated, for example, by the adhesion of substances contained in the treatment-undergoing liquid. Thus, the filtration capability is decreased if no action is taken.

To solve the problem, a cleaning method (an air scrubbing) has been employed conventionally that feeds air bubbles from under the filtration module to scrub the surface of the individual hollow-fiber membranes and that vibrates the individual membranes to remove the adhered substances (see the published Japanese patent application Tokukai 2010-42329).

### CITATION LIST

### Patent Literature

Patent Literature 1: the published Japanese patent application Tokukai 2010-42329.

### SUMMARY OF INVENTION

### Technical Problem

In the above-described conventional filtration apparatus, cleaning air bubbles having a small volume are continuously supplied. Generally, the air bubbles have a diameter on the order of several millimeters. However, when the volume of the air bubbles is small as described above, the air bubbles tend to be drifted by a circular stream in the water bath. The drifting easily creates variations in the contact of air bubbles to the hollow-fiber membranes. As a result, some portions of the surface of the hollow-fiber membranes may not be cleaned. In addition, the cleaning by gas in the conventional filtration apparatus may result in insufficient removal of adhered substances because the small volume of the air bubbles applies small pressure to the hollow-fiber membranes while scrubbing the surface of them. As described above, there is room for further improvement in the technique for cleaning the surface of the hollow-fiber membranes.

The present invention is made based on the above-described circumstances. An object of the present invention is to offer both a filtration apparatus that has excellent capability to clean the surface of the hollow-fiber membranes and that can maintain high filtration capability and a filtration method that uses the foregoing filtration apparatus.

### Solution to Problem

An invention that is made to solve the above-described problem is a filtration apparatus that is an immersion type and that is provided with:
a filtration module having multiple hollow-fiber membranes held in a state in which they are arranged by being pulled unidirectionally; and
a gas supplier that supplies gas bubbles from under the filtration module.
   In the filtration apparatus, each of the gas bubbles supplied by the above-described gas supplier is divided into a plurality of gas bubbles after colliding against the filtration module.

Another invention that is made to solve the above-described problem is an immersion-type filtration method using the above-described filtration apparatus.

### Advantageous Effects of Invention

The filtration apparatus and immersion-type filtration method of the present invention have an excellent capability to clean the surface of the hollow-fiber membranes and can maintain their high filtration capability. In other words, the filtration apparatus and immersion-type filtration method of the present invention can clean the surface of the hollow-fiber membranes uniformly and by applying high pressure.

### BRIEF DESCRIPTION OF DRAWINGS

FIG. 1 is a schematic illustration showing a filtration apparatus in an embodiment of the present invention.

FIG. 2a is a schematic plan view showing a lower holding member included in a filtration module of the filtration apparatus shown in FIG. 1.

FIG. 2b is the A-A cross section of the lower holding member shown in FIG. 2a.

FIG. 3a is a schematic plan view of the filtration apparatus in an embodiment different from the filtration apparatus shown in FIG. 1, when viewed from above.

FIG. 3b is the B-B cross section of the filtration apparatus shown in FIG. 3a.

FIG. 4 is a schematic cross-sectional view showing a lower holding member having a shape different from that of the lower holding member shown in FIG. 2b.

FIG. 5 is a schematic plan view showing a lower holding member having a shape different from that of the lower holding member shown in FIG. 2a.

FIG. 6 is a graph showing an operation result in Example 1.

FIG. 7 is a graph showing an operation result in Example 2.

FIG. 8 is a graph showing an operation result in Comparative example 1.

### DESCRIPTION OF EMBODIMENTS

### Explanation of Embodiments of the Present Invention

The present invention is a filtration apparatus that is an immersion type and that is provided with both a filtration module having multiple hollow-fiber membranes held in a state in which they are arranged by being pulled unidirectionally and a gas supplier that supplies gas bubbles from under the filtration module. In the filtration apparatus, each of the gas bubbles supplied by the above-described gas supplier is divided into a plurality of gas bubbles after colliding against the filtration module.

In the foregoing filtration apparatus, each of the gas bubbles supplied by the gas supplier is divided into a plurality of gas bubbles by the hollow-fiber membranes or their holding member. The divided gas bubbles ascend while maintaining contact with the surface of the hollow-fiber membranes. The divided gas bubbles have an average diameter close to the spacing of the hollow-fiber membranes, so that they easily spread uniformly between the hollow-fiber membranes. As a result, the divided gas bubbles can clean the surface of the hollow-fiber membranes without omission. In addition, the foregoing divided gas bubbles have an ascending speed higher than that of the conventional minute gas bubbles, so that they can clean the surface of the hollow-fiber membranes effectively at high scrubbing pressure.

The present inventors have found that gas bubbles divided, as described above, by hollow-fiber membranes or their holding member can facilitate shaking the hollow-fiber membranes and that the shaking of the hollow-fiber membranes can significantly suppress the pressure loss in the filtration module from increasing. More specifically, in a common filtration module using a plurality of hollow-fiber membranes, the hollow-fiber membranes are brought into contact with one another by the water stream and impurities are deposited at a space between the hollow-fiber membranes brought into contact, so that the surface area of the hollow-fiber membranes are decreased and the pressure loss in the filtration module tends to increase. In contrast, in the filtration apparatus of the present invention, the divided gas bubbles effectively shake the hollow-fiber membranes of the filtration module. The shaking can not only separate the hollow-fiber membranes with one another but also remove impurities deposited on the surface of the hollow-fiber membranes. As a result, the foregoing filtration apparatus can maintain the filtration capability at a higher level than that of the conventional filtration apparatus.

It is desirable that the average horizontal diameter of the gas bubbles supplied by the above-described gas supplier be larger than the maximum spacing of holding portions in the multiple hollow-fiber membranes in the above-described filtration module. As described above, when the average horizontal diameter of the gas bubbles supplied by the gas supplier is made larger than the maximum spacing of holding portions in the multiple hollow-fiber membranes, gas bubbles having an average diameter close to the spacing of the hollow-fiber membranes can be spread uniformly in a space between the hollow-fiber membranes with higher reliability. In the above description, the term “the average horizontal diameter of the gas bubbles” means the average value of the minimum widths in the horizontal directions of the gas bubbles delivered by the gas supplier directly before they collide against the hollow-fiber membranes or their holding member. In addition, the term “the maximum spacing of holding portions in the hollow-fiber membranes” means the maximum spacing among the spacings of the holding portions in neighboring hollow-fiber membranes.

It is desirable that the above-described filtration module have an upper holding member and a lower holding member both for positioning the multiple hollow-fiber membranes in the upward-downward direction, that the upper holding member communicate with upper openings of the multiple hollow-fiber membranes and have an outlet that collects filtrated liquids, and that the above-described gas supplier be located at a position under the above-described lower holding member. When the filtration module has the above-described upper holding member and lower holding member, the above-described divided gas bubbles ascend along the individual hollow-fiber membranes in the longitudinal direction. Consequently, the filtration apparatus can clean the surface of the hollow-fiber membranes effectively at higher efficiency.

When the above-described filtration module has an upper holding member and a lower holding member both for positioning the multiple hollow-fiber membranes in the upward-downward direction, it is desirable that the filtration apparatus be further composed of a guide cover that surrounds at least an upper portion of the above-described multiple hollow-fiber membranes. When the guide cover is provided that surrounds the hollow-fiber membranes as described above, the guide cover can not only prevent the cleaning gas bubbles from scattering as they ascend but also increase the ascending speed of the gas bubbles. As a result, the surface-cleaning efficiency and shaking effect of the hollow-fiber membranes can be further increased.

Consequently, the immersion-type filtration method using the foregoing filtration apparatus can clean the surface of the hollow-fiber membranes effectively and maintain high treatment capability at low running cost.

### DETAIL OF EMBODIMENTS OF THE PRESENT INVENTION

Embodiments of the filtration apparatus of the present invention are explained below in detail by referring to drawings.

### First Embodiment

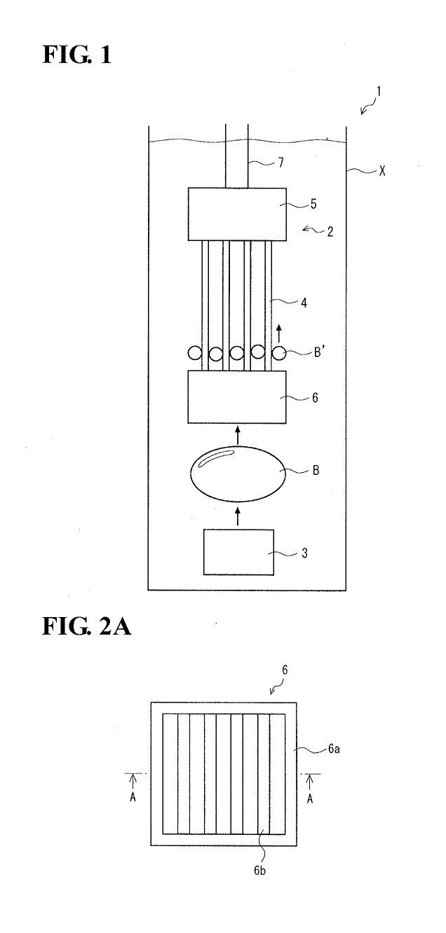

A filtration apparatus 1 shown in FIG. 1 is provided with a filtration module 2 and a gas supplier 3 that supplies gas bubbles from under the filtration module 2. The filtration apparatus 1 is used by being immersed in a filtration bath X that stores a treatment-undergoing liquid.

### Filtration Module

The filtration module 2 has a plurality of hollow-fiber membranes 4 that are aligned by being pulled in the upward-downward direction and has an upper holding member 5 and a lower holding member 6 both for positioning the multiple hollow-fiber membranes 4 in the upward-downward direction.

### Hollow-Fiber Membrane

The hollow-fiber membranes 4 are porous hollow-fiber membranes that permeate water into the inside hollow portion of them while preventing the permeation of particles contained in the treatment-undergoing liquid.

The hollow-fiber membranes 4 are formed by using a material that can be composed mainly of thermoplastic resin. The types of the thermoplastic resin include polyethylene, polypropylene, polyvinylidene fluoride, an ethylene-vinyl alcohol copolymer, polyamide, polyimide, polyetherimide, polystyrene, polysulfone, polyvinyl alcohol, polyphenylene ether, polyphenylene sulfide, cellulose acetate, polyacrylonitrile, and polytetrafluoroethylene (PTFE). Among these thermoplastic resins, it is desirable to use PTFE, which has excellent chemical resistance, heat resistance, weather resistance, and incombustibility and which is porous, more desirably uniaxially or biaxially stretched PTFE. The material for forming the hollow-fiber membranes 4 may contain, for example, another polymer and an additive such as a lubricant as appropriate.

It is desirable that the hollow-fiber membrane 4 have a multilayer structure to combine water permeability and mechanical strength and to render the surface cleaning effect by gas bubbles effective. More specifically, it is desirable that the hollow-fiber membrane 4 be provided with a supporting layer at the inner side and a filtration layer stacked on the surface of the supporting layer.

The above-described supporting layer can be formed by using a tube obtained by extruding thermoplastic resin, for example. The use of an extruded tube as the supporting layer enables the supporting layer to have mechanical strength and facilitates the formation of pores. It is desirable that the tube be stretched axially at a streching ratio of 50% or more and 700% or less and circumferentially at 5% or more and 100% or less.

It is desirable that the above-described stretching be performed at a temperature of the melting point of the tube material or below, for example, 0° C. to 300° C. or so. To obtain a porous body having relatively large pores, it is desirable to stretch at low temperature. To obtain a porous body having relatively small pores, it is desirable to stretch at high temperature. When a stretched porous body is heat-treated for 1 to 30 minutes or so at a temperature of 200° C. to 300° C. while being maintained in the as-stretched state with its both ends being fixed, high dimensional stability can be achieved. The dimension of the pores of the porous body can be adjusted by combining the stretching temperature, the streching ratio, and other conditions.

When PTFE is used as the forming material of the supporting layer, the tube that forms the supporting layer can be obtained by blending a liquid lubricant such as naphtha into, for example, a PTFE fine powder, then by performing extrusion or other process to obtain the shape of a tube, and finally by stretching the tube. When the tube is baked for several-ten seconds to several minutes or so in a heating furnace maintained at a temperature of the melting point of the PTFE fine powder or above, for example, 350° C. to 550° C. or so, the dimensional stability can be increased.

It is desirable that the foregoing PTFE fine powder have a lower limit of 500,000 in the number-average molecular weight, more desirably 2,000,000. When the number-average molecular weight of the PTFE fine powder is less than the above-described lower limit, the surface of the hollow-fiber membrane 4 may be damaged or the mechanical strength may be decreased by the scrubbing of gas bubbles. On the other hand, it is desirable that the foregoing PTFE fine powder have an upper limit of 20,000,000 in number-average molecular weight. When the number-average molecular weight of the PTFE fine powder exceeds the above-described upper limit, the formation of pores in the hollow-fiber membrane 4 may become difficult. In the above description, the term “number-average molecular weight” means the value measured by gel filtration chromatography.

It is desirable that the supporting layer have an average thickness of 0.1 mm or more and 3 mm or less. When the supporting layer has an average thickness falling within the above-described range, the hollow-fiber membrane 4 can have well-balanced mechanical strength and water permeability.

The above-described filtration layer can be formed by wrapping, for example, a sheet of thermoplastic resin around the foregoing supporting layer and then by baking it. The use of a sheet as the material to form the filtration layer facilitates the stretching operation, enables easy adjustment of the shape and size of the pores, and can decrease the thickness of the filtration layer. The process of sheet wrapping and subsequent baking can unify the filtration layer and the supporting layer and can increase the water permeability by communicating the filtration layer's pores with the supporting layer's pores. It is desirable that the baking temperature be at least the melting point of the tube that forms the supporting layer or at least the melting point of the sheet that forms the filtration layer, whichever is higher.

The sheet that forms the above-described filtration layer can be obtained by the following methods, for example: (1) a method in which an unbaked formed body obtained by extruding a resin is stretched at a temperature of its melting point or lower and then is baked, and (2) a method in which a baked resin formed body is cooled gradually to increase the crystallinity and then is stretched. It is desirable that the sheet be stretched longitudinally at a streching ratio of 50% or more and 1,000% or less and laterally at 50% or more and 2,500% or less. In particular, when the streching ratio in the lateral direction is controlled to fall within the foregoing range, the circumferential mechanical strength can be increased after the sheet wrapping is performed. As a result, the durability can be increased against the surface cleaning by gas bubbles having a large volume.

When the filtration layer is formed by wrapping the sheet around the tube that forms the supporting layer, it is desirable to provide microscopic asperities on the outer circumferential surface of the tube. The providing of the asperities on the outer circumferential surface of the tube can not only prevent, the sheet from deviating from the predetermined position but also increase the intimate contact between the tube and the sheet and prevent the filtration layer from separating from the supporting layer by the cleaning by gas bubbles. The number of wrapping turns of the sheet can be adjusted by the thickness of the sheet and can be one turn or a plurality of turns. In addition, a plurality of sheets may be wrapped around the tube. The method of wrapping of the sheet has no particular limitation. The sheet may be wrapped circumferentially or helically around the tube.

It is desirable that the above-described microscopic asperities have a magnitude (the height difference between the crest and the trough) of 20 μm or more and 200 μm or less.

Although it is desirable that the foregoing microscopic asperities be formed on the entire outer circumferential surface of the tube, they may be formed partially or intermittently. The methods of forming the foregoing microscopic asperities on the outer circumferential surface of the tube include surface treatment by flames, laser irradiation, plasma irradiation, and dispersion coating of fluorine-based resin or others. Of these methods, surface treatment by flames is desirable because it can easily form asperities without affecting the shape and property of the tube.

In addition, an unbaked tube and an unbaked sheet may also be used. In this case, to increase the intimate contact with each other, baking is performed after the sheet is wrapped.

It is desirable that the filtration layer have an average thickness of 5 μm or more and 100 μm or less. When the average thickness of the filtration layer is controlled to fall within the foregoing range, the hollow-fiber membranes 4 can have high filtration performance easily and reliably.

It is desirable that the hollow-fiber membranes 4 have an upper limit of 6 mm in the average outer diameter, more desirably 4 mm. When the average outer diameter of the hollow-fiber membranes 4 exceeds the above-described upper limit, the ratio of the surface area to the cross-sectional area in the hollow-fiber membranes 4 is decreased, so that the filtration efficiency may be decreased. On the other hand, it is desirable that the hollow-fiber membranes 4 have a lower limit of 2 mm in the average outer diameter, more desirably 2.1 mm. When the average outer diameter of the hollow-fiber membranes 4 is less than the above-described lower limit, the mechanical strength of the hollow-fiber membranes 4 may become insufficient.

It is desirable that the hollow-fiber membranes 4 have an upper limit of 4 mm in the average inner diameter, more desirably 3 mm. When the average inner diameter of the hollow-fiber membranes 4 exceeds the above-described upper limit, the thickness of the hollow-fiber membranes 4 is decreased, so that the mechanical strength and the impurity permeation prevention effect may become insufficient. On the other hand, it is desirable that the hollow-fiber membranes 4 have a lower limit of 0.5 mm in the average inner diameter, more desirably 0.9 mm. When the average inner diameter of the hollow-fiber membranes 4 is less than the above-described lower limit, the pressure loss may be increased at the time the filtrated liquid in the hollow-fiber membranes 4 is discharged.

It is desirable that the hollow-fiber membranes 4 have an upper limit of 0.8 in the ratio of the average inner diameter to the average outer diameter, more desirably 0.6. When the ratio of the average inner diameter to the average outer diameter in the hollow-fiber membranes 4 exceeds the above-described upper limit, the thickness of the hollow-fiber membranes 4 is decreased, so that the mechanical strength, the impurity permeation prevention effect, and the durability against the surface cleaning by gas bubbles having a large volume may become insufficient. On the other hand, it is desirable that the hollow-fiber membranes 4 have a lower limit of 0.3 in the ratio of the average inner diameter to the average outer diameter, more desirably 0.4. When the ratio of the average inner diameter to the average outer diameter in the hollow-fiber membranes 4 is less than the above-described lower limit, the thickness of the hollow-fiber membranes 4 is increased more than necessary, so that the water permeability of the hollow-fiber membranes 4 may be decreased.

The average length of the hollow-fiber membranes 4 is not particularly limited. For example, it can be 1 m or more and 6 m or less. The term “average length of the hollow-fiber membranes 4” means the average distance from the upper end portion fixed by the upper holding member 5 to the lower end portion fixed by the lower holding member 6. As described below, when one hollow-fiber membrane 4 is bent in the shape of the letter U and the bent portion is positioned as the lower end portion and fixed with the lower holding member 6, the foregoing term means the average distance from this lower end portion to the upper end portion (the openings).

It is desirable that the hollow-fiber membrane 4 have an upper limit of 90% in porosity, more desirably 85%. When the porosity of the hollow-fiber membrane 4 exceeds the above-described upper limit, the mechanical strength and resistance to scrubbing of the hollow-fiber membrane 4 may become insufficient. On the other hand, it is desirable that the hollow-fiber membrane 4 have a lower limit of 75% in porosity, more desirably 78%. When the porosity of the hollow-fiber membrane 4 is less than the above-described lower limit, the water permeability is decreased, so that the filtration capability of the filtration apparatus 1 may be decreased. In the above description, the term “porosity” means the percentage of the total volume of the pores in the volume of the hollow-fiber membrane 4. The porosity can be obtained by measuring the density of the hollow-fiber membrane 4 in accordance with ASTM-D-792.

It is desirable that the hollow-fiber membrane 4 have an upper limit of 60% in the area-occupying percentage of the pores. When the area-occupying percentage of the pores exceeds the above-described upper limit, the surface strength of the hollow-fiber membrane 4 becomes insufficient, so that the hollow-fiber membrane 4 may suffer damage or another trouble owing to the scrubbing of gas bubbles. On the other hand, it is desirable that the hollow-fiber membrane 4 have a lower limit of 40% in the area-occupying percentage of the pores. When the area-occupying percentage of the pores is less than the above-described lower limit, the water permeability is decreased, so that the filtration capability of the filtration apparatus 1 may be decreased. In the above description, the term “the area-occupying percentage of the pores” means the percentage of the total area of the pores in the outer circumferential surface (the surface of the filtration layer) of the hollow-fiber membrane 4 against the surface area of the hollow-fiber membrane 4. The area-occupying percentage of the pores can be obtained by analyzing the electron microscope photograph of the outer circumferential surface of the hollow-fiber membrane 4.

It is desirable that the hollow-fiber membrane 4 have an upper limit of 0.45 μm in the average diameter of the pores, more desirably 0.1 μm. When the average diameter of the pores of the hollow-fiber membrane 4 exceeds the above-described upper limit, impurities contained in the treatment-undergoing liquid may not be prevented from permeating into the inside of the hollow-fiber membrane 4. On the other hand, it is desirable that the hollow-fiber membrane 4 have a lower limit of 0.01 μm in the average diameter of the pores. When the average diameter of the pores of the hollow-fiber membrane 4 is less than the above-described lower limit, the water permeability may be decreased. In the above description, the term “the average diameter of the pores” means the average diameter of the pores in the outer circumferential surface (the surface of the filtration layer) of the hollow-fiber membrane 4. The average diameter of the pores can be measured with a pore diameter distribution measuring apparatus (for example, Automated Microscopic Pore Diameter Distribution Measurement System for Porous Materials; made by Porous Materials, Inc.)

It is desirable that the hollow-fiber membrane 4 have a lower limit of 50 N in tensile strength, more desirably 60 N. When the tensile strength of the hollow-fiber membrane 4 is less than the above-described lower limit, the durability against the surface cleaning by gas bubbles having a large volume may decrease. Generally, the upper limit of the tensile strength of the hollow-fiber membrane 4 is 150 N. In the above description, the term “tensile strength” means the maximum tensile stress when a tensile test is performed in accordance with JIS-K7161: 1994 and at a reference line distance of 100 mm and a testing speed of 100 mm/min.

### Upper Holding Member and Lower Holding Member

The upper holding member 5 is a member for holding the upper end portions of a plurality of hollow-fiber membranes 4. The upper holding member 5 communicates with upper openings of the multiple hollow-fiber membranes 4 and is provided with a discharging portion (a water-collecting header) that collects filtrated liquids. The discharging portion is connected with a discharging pipe 7 and discharges filtrated liquids having permeated into the inside of the multiple hollow-fiber membranes 4. The outside shape of the upper holding member 5 is not particularly limited, and the types of its cross-sectional shape can include a polygonal shape and a circular shape.

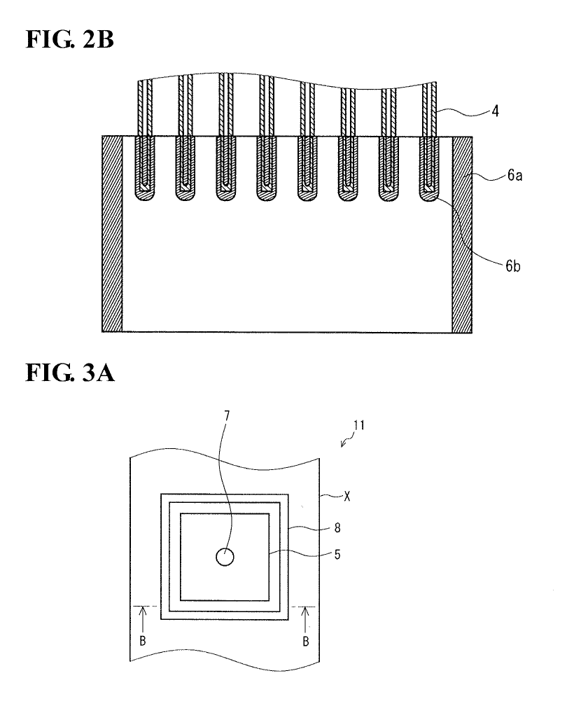

The lower holding member 6 is a member for holding the lower end portions of a plurality of hollow-fiber membranes 4. As shown in FIGS. 2a and 2b, the foregoing lower holding member 6 is provided with an outer frame 6a and a plurality of fixing parts 6b for fixing the lower portions of the hollow-fiber membranes 4. The fixing parts 6b have the shape of a bar, for example, and are placed nearly in parallel with one another at a uniform spacing. The multiple hollow-fiber membranes 4 are placed individually on the upper side of the fixing parts 6b. The placing of the fixing parts 6b nearly in parallel with one another at a uniform spacing enables more uniform division of a gas bubble.

Although the hollow-fiber membranes 4 may be fixed individually in such a way that one end of one membrane is fixed with the upper holding member 5 and the other end of the membrane is fixed with the lower holding member 6, they may also be fixed in such a way that one hollow-fiber membrane 4 is bent in the shape of the letter U, and the two openings are fixed with the upper holding member 5, and the turning-up portion (the bent portion) at the bottom is fixed with the lower holding member 6.

The outer frame 6a is a member for holding the fixing parts 6b. One side of the outer frame 6a can have a length of 50 mm or more and 200 mm or less, for example. The cross-sectional shape of the outer frame 6a is not particularly limited. In addition to the quadrangular shape shown in FIG. 2a, it may have another polygonal shape or a circular shape.

A gas bubble B supplied by the gas supplier 3, which is described later, collides against the fixing parts 6b and is divided into a plurality of gas bubbles B′. The divided gas bubbles B′ pass through the gaps between the fixing parts 6b and travel upward while scrubbing the surface of the hollow-fiber membranes 4. As shown in FIG. 2b, the multiple fixing parts 6b are placed in aligned positions in the upward-downward direction.

The fixing parts 6b's width (lateral dimension) and spacing are not particularly limited on condition that a sufficient number of hollow-fiber membranes 4 can be fixed and each of the gas bubbles supplied by the gas supplier 3 can be divided into a plurality of gas bubbles. The fixing parts 6b may have a width of 3 mm or more and 10 mm or less, for example, and a spacing of 1 mm or more and 10 mm or less, for example.

The number, N, of hollow-fiber membranes 4 held by the lower holding member 6 is divided by the area, A, of the placing region of the hollow-fiber membranes 4 to obtain the existing density of the hollow-fiber membranes 4 (N/A). It is desirable that the existing density have an upper limit of 15 membranes/cm², more desirably 12 membranes/cm². When the existing density of the hollow-fiber membranes 4 exceeds the above-described upper limit, the spacing of the hollow-fiber membranes 4 becomes small, so that the surface cleaning may not be performed sufficiently or the shaking of the hollow-fiber membranes 4 may not be sufficiently created. On the other hand, it is desirable that the existing density of the hollow-fiber membranes 4 have a lower limit of 4 membranes/cm², more desirably 6 membranes/cm². When the existing density of the hollow-fiber membranes 4 is less than the above-described lower limit, the filtration efficiency per unit volume of the filtration apparatus 1 may be decreased. In the above description, the term “the placing region of the hollow-fiber membranes” means the polygon having the smallest area among imaginal polygons each including all hollow-fiber membranes 4 belonging to the filtration module 2 when viewed from the axial direction.

In addition, when the hollow-fiber membranes are assumed to be solid, the sum total, S, of the cross-sectional areas of the hollow-fiber membranes 4 held by the lower holding member 6 is divided by the area, A, of the placing region of the hollow-fiber membranes 4 to obtain the area percentage of the hollow-fiber membranes 4 (S/A). It is desirable that the area percentage have an upper limit of 60%, more desirably 55%. When the area percentage of the hollow-fiber membranes 4 exceeds the above-described upper limit, the spacing of the hollow-fiber membranes 4 becomes small, so that the surface cleaning may not be performed sufficiently. On the other hand, it is desirable that the area percentage of the hollow-fiber membranes 4 have a lower limit of 20%, more desirably 25%. When the area percentage of the hollow-fiber membranes 4 is less than the above-described lower limit, the filtration efficiency per unit volume of the filtration apparatus 1 may be decreased.

The material of the upper holding member 5 and the lower holding member 6 is not particularly limited. For example, epoxy resin, ABS resin, and silicone resin can be used.

The method of fixing the hollow-fiber membranes 4 to the upper holding member 5 and the lower holding member 6 is not particularly limited. For example, an adhesive can be used for fixing them.

In addition, to facilitate the handling (transportation, placing, changing, etc.) of the filtration module 2, it is desirable to connect the upper holding member 5 with the lower holding member 6 with a connecting member. As the connecting member, for example, a supporting bar made of metal or a casing (an outer cylinder) made of resin can be used.

### Gas Supplier

The gas supplier 3 supplies from under the above-described filtration module 2 a gas bubble B for cleaning the surface of the hollow-fiber membranes 4. As described above, the gas bubble B is divided into a plurality of gas bubbles B′ by the above-described fixing parts 6b. The divided gas bubbles B′ scrub the surface of the hollow-fiber membranes 4 to clean them. The gas supplier 3 has one gas-bubble outlet. In other words, the filtration apparatus 1 has a gas-bubble outlet associated with one filtration module 2 on a one-to-one basis.

As the foregoing gas supplier 3, a well-known supplier can be used. For example, a gas supplier can be used that is immersed in a treatment-undergoing liquid together with the above-described filtration module 2, that stores at its inside a gas continuously supplied by a compressor or the like through a gas-feeding pipe (not shown), and that supplies the gas bubble B by delivering intermittently a gas that has accumulated to a predetermined volume.

The average horizontal diameter of the gas bubbles supplied by the gas supplier 3 is larger than the maximum spacing of fixing portions (fixing places to the fixing parts 6b) in the multiple hollow-fiber membranes 4 in the filtration module 2. It is desirable that the lower limit of the average horizontal diameter of the gas bubbles supplied by the gas supplier 3 be two times the maximum spacing of fixing portions in the multiple hollow-fiber membranes 4 in the filtration module 2, more desirably three times, preferably four times. When the average horizontal diameter of the gas bubbles supplied by the gas supplier 3 is less than the above-described lower limit, the number and size of gas bubbles after being divided by the fixing parts 6b are insufficient, so that the capability of the gas bubbles to clean the surface of the hollow-fiber membranes 4 may become insufficient. In the above description, the term “the average horizontal diameter of the gas bubbles” means the average value of the minimum widths in the horizontal directions of the gas bubbles delivered by the gas supplier 3 directly before they collide against the lower holding member 6. The term “the maximum spacing of fixing portions in the hollow-fiber membranes” means the maximum spacing among the spacings of the holding portions in neighboring hollow-fiber membranes 4, the holding portions being the portions held by the lower holding member 6.

The gas to be supplied by the gas supplier 3 is not particularly limited provided that it is an inert gas. It is desirable to use air in view of the running cost.

### Operation Method

The filtration apparatus 1 can be used by being immersed in a filtration bath storing a treatment-undergoing liquid to be filtrated. The concrete applications of the filtration apparatus 1 include wastewater treatment; industrial wastewater treatment; industrial tap-water filtration; treatment of water for cleaning machines or the like; filtration of pool water; filtration of river water; filtration of sea water; disinfection and removal of muddiness in a fermentation process (purification of enzymes and amino acids); filtration of food, rice wine, beer, wine, and the like (particularly uncooked products); separation of a bacterial cell from a fermenter in pharmacy and the like; filtration of service water and a dissolved dye in the dye industry; culturing filtration of animal cells; pretreatment filtration in a pure water manufacturing process (including desalination of sea water) using an RO membrane; pretreatment filtration in a process using an ion exchange membrane; and pre-treatment filtration in a pure water manufacturing process using an ion exchange resin.

In water purification treatment, the filtration apparatus 1 can be used in combination with powdered activated carbon. First, microscopic dissolved organic substances are adsorbed by the powdered activated carbon. Then, the water containing the powdered activated carbon having adsorbed the dissolved organic substances is filtrated with the filtration apparatus 1. This process can perform the water purification treatment effectively.

In wastewater treatment, the filtration apparatus 1 can be used in combination with a tank in which bacterial cells are bred. First, wastewater is introduced into the tank. The bacterial cells decompose contaminated ingredients in the wastewater to clean the wastewater. Then, the wastewater containing the bacterial cells is filtrated with the filtration apparatus 1. This process can perform the wastewater treatment effectively.

### Advantage

In the filtration apparatus 1, the average horizontal diameter of the gas bubbles B supplied by the gas supplier 3 is larger than the maximum spacing of the fixing portions of the multiple hollow-fiber membranes 4. Consequently, each of the gas bubbles B is divided into a plurality of gas bubbles B′ by the fixing parts 6b. The divided gas bubbles B′ ascend while maintaining contact with the surface of the hollow-fiber membranes 4. The divided gas bubbles B′ have an average diameter close to the spacing of the hollow-fiber membranes 4, so that they easily spread uniformly between the hollow-fiber membranes 4. As a result, the divided gas bubbles B′ can clean the surface of the hollow-fiber membranes 4 without omission. In addition, the foregoing divided gas bubbles B′ have an ascending speed higher than that of the conventional minute gas bubbles, so that they can clean the surface of the hollow-fiber membranes 4 effectively at high scrubbing pressure. Because the divided gas bubbles B′ ascend along the individual hollow-fiber membranes 4 longitudinally, the filtration apparatus 1 can clean the surface of the hollow-fiber membranes 4 effectively at higher efficiency.

Furthermore, the filtration apparatus 1 easily shake the hollow-fiber membranes 4 by using the gas bubbles divided by the lower holding member 6. By effectively shaking the hollow-fiber membranes 4 as described above, the filtration apparatus 1 can not only separate the hollow-fiber membranes 4 from one another but also remove impurities deposited on the surface of the hollow-fiber membranes 4.

In the filtration apparatus 1, by using the gas supplier 3, which stores at its inside a continuously fed gas to deliver it intermittently for the supply of gas bubbles, gas bubbles having a large volume can be supplied to the filtration module 2 easily and reliably at low cost.

### Immersion-Type Filtration Method

The immersion-type filtration method using the filtration apparatus 1 can perform filtration treatment while maintaining high filtration efficiency because the surface of the hollow-fiber membranes 4 of the filtration apparatus 1 is kept clean by gas bubbles as described above.

### Second Embodiment

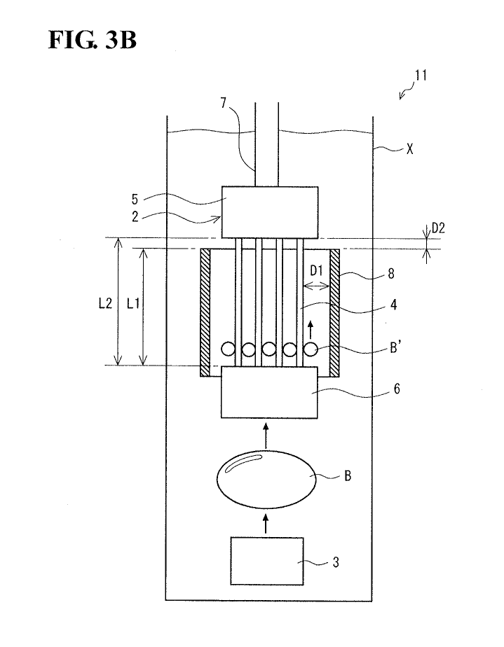

A filtration apparatus 11 shown in FIGS. 3a and 3b is provided with a filtration module 2, a gas supplier 3 that supplies gas bubbles from under the filtration module 2, and a guide cover 8 that surrounds a plurality of hollow-fiber membranes 4 of the above-described filtration module 2. The filtration apparatus 11 is used by being immersed in a filtration bath X that stores a treatment-undergoing liquid. The filtration module 2 and the gas supplier 3 are the same as those used in the filtration apparatus 1 in the above-described first embodiment. Consequently, they are given the same signs, and their explanation is omitted.

### Guide Cover

The guide cover 8 is a cylindrical body that surrounds the multiple hollow-fiber membranes 4 of the filtration module 2. The guide cover 8 surrounds at least an upper portion of the hollow-fiber membranes 4 to prevent the cleaning gas bubbles B′ from scattering at the upper portion of the filtration module 2.

It is desirable that the guide cover 8 be placed at some distance in the upward-downward direction from the upper holding member 5. More specifically, it is desirable that the guide cover 8 do not surround the upper holding member 5 and that a space be formed between the two members. As described above, by separating the guide cover 8 from the upper holding member 5, impurities (residues) separated from the hollow-fiber membranes 4 by dint of the gas bubbles can be discharged to the outside of the filtration module 2 through the space between the guide cover 8 and the upper holding member 5. Thus, the cleaning effect can be increased. On the other hand, it is desirable that the guide cover 8 surround a part of the lower holding member 6.

It is desirable that the length L1, which is the length in the upward-downward direction of the surrounding region of the guide cover 8 around the hollow-fiber membranes 4, have a lower limit of 30% of the average distance L2 between the upper holding member 5 and the lower holding member 6, more desirably 50%, preferably 80%. On the other hand, it is desirable that the length L1 of the above-described surrounding region have an upper limit of 100% of the average distance L2 between the upper holding member 5 and the lower holding member 6, more desirably 98%, preferably 95%. When the length L1 of the above-described surrounding region is less than the above-described lower limit, the effect of preventing the scattering of the gas bubbles B′ and the effect of increasing the ascending speed of the gas bubbles B′ may become insufficient. Inversely, when the length L1 of the above-described surrounding region exceeds the above-described upper limit, it becomes difficult to discharge the impurities separated from the hollow-fiber membranes 4 to the outside of the filtration module 2, so that the cleaning effect may not be increased sufficiently.

It is desirable that the average distance Dl, which is the average of the distances between the inner surface of the guide cover 8 and hollow-fiber membranes 4 in the immediate vicinity of the guide cover 8, have a lower limit of 20 mm, more desirably 30 mm, preferably 40 mm. On the other hand, it is desirable that the above-described average distance D1 have an upper limit of 400 mm, more desirably 250 mm, preferably 100 mm. When the above-described average distance D1 exceeds the above-described upper limit, the effect of preventing the scattering of the gas bubbles may become insufficient. Inversely, when the above-described average distance D1 is less than the above-described lower limit, these hollow-fiber membranes 4 may be brought into contact with the guide cover 8, so that the cleaning and shaking of these hollow-fiber membranes 4 may become insufficient and the surface of these hollow-fiber membranes 4 may be worn out.

A separating distance D2 in the upward-downward direction between the guide cover 8 and the upper holding member 5 can be 50 mm or more and 200 mm or less, for example.

The shape of the undersurface of the guide cover 8 is not limited to the rectangle shown in FIG. 3a. It can be designed as appropriate in accordance with the outer shape of the upper holding member 5 and the lower holding member 6, the arranging shape of the multiple hollow-fiber membranes 4, and the like. It can be a circle or another polygon other than the rectangle.

As the material for the guide cover 8, for example, in addition to the same resin used for the upper holding member 5 or the lower holding member 6, polyvinyl chloride and stainless steel may be used.

### Advantage

The filtration apparatus 11 is provided with the guide cover 8 that surrounds the hollow-fiber membranes 4 of the filtration module 2. Consequently, it can not only prevent the cleaning gas bubbles B′ from scattering as they ascend but also increase the ascending speed of the gas bubbles B′. Therefore, the filtration apparatus 11 is excellent in the surface-cleaning efficiency and shaking effect of the hollow-fiber membranes 4.

### Other Embodiments

It is to be understood that the embodiments disclosed this time are illustrative and not restrictive in all aspects. It is intended that the scope of the present invention is not limited to the structure of the above-described embodiments, is shown by the scope of the claims, and covers all revisions and modifications included within the meaning and scope equivalent to the scope of the claims.

The filtration apparatus of the present invention may be provided with a plurality of filtration modules. When the filtration apparatus is provided with multiple filtration modules, a gas supplier may be placed under each filtration module. Alternatively, a gas supplier may be placed that has a plurality of gas-bubble outlets capable of supplying gas bubbles to the multiple filtration modules. In addition, a plurality of filtration modules may be placed within one guide cover.

The above-described embodiments have a configuration in which the lower holding member 6 has bar-shaped fixing parts 6b each holding multiple hollow-fiber membranes 4. However, the scope of the present invention is not limited to this configuration. For example, a configuration can be employed in which one fixing part 6b holds one hollow-fiber membrane 4 and a plurality of fixing parts 6b are placed in such a way that they are separated with one another with a spacing.

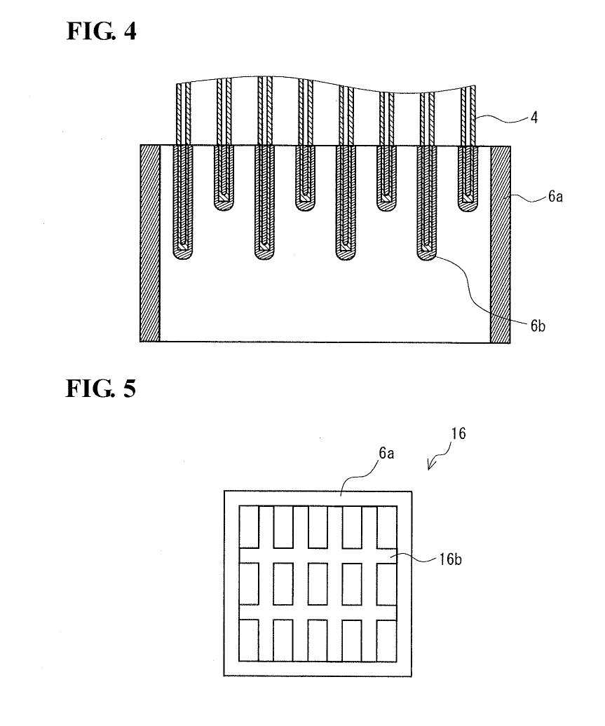

In addition, as shown in FIG. 4, neighboring fixing parts 6b may be placed at different positions in the upward-downward direction. When neighboring fixing parts 6b are placed unevenly as described above, the shearing force of the fixing parts 6b is increased against gas bubbles, so that gas bubbles can be divided more uniformly.

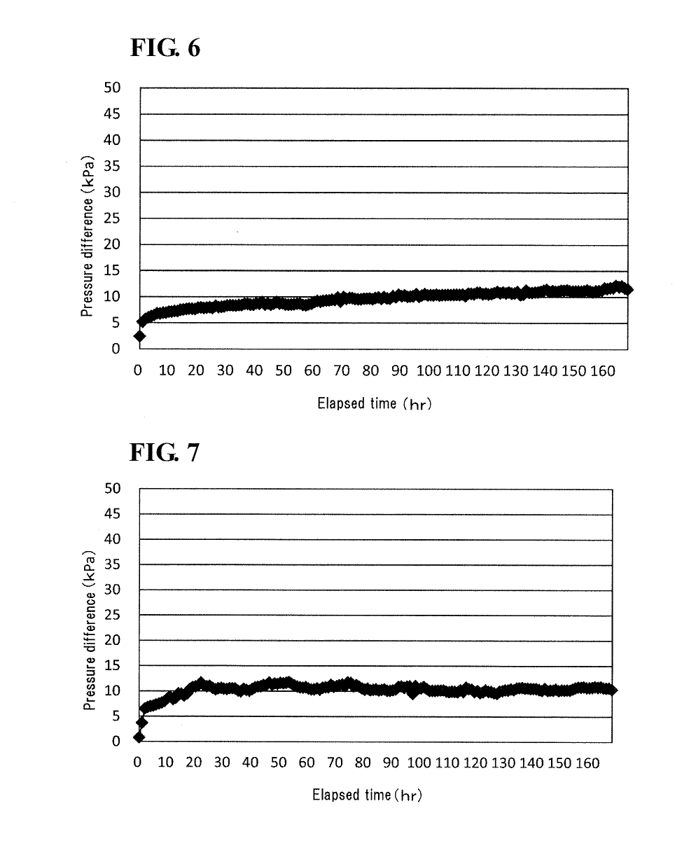

The shape of the lower holding member 6, also, is not limited to the shape having the bar-shaped fixing parts 6b as shown in the above-described embodiments. For example, like a lower holding member 16 shown in FIG. 5, a shape may also be employed in which a plate-shaped fixing part 16b is provided with a plurality of through holes.

The gas supplier to be used in the filtration apparatus is required only to supply a gas bubble having a sufficient volume so that it can be divided into a plurality of gas bubbles after colliding against the filtration module. Consequently, a gas-bubble-generating apparatus (a gas diffuser) other than the gas supplier explained in the above-described embodiments may also be used. Furthermore, two or more gas suppliers (two or more gas-bubble outlets) may also be placed for one filtration module.

The filtration module of the filtration apparatus can have a structure in which the two ends of the multiple hollow-fiber membranes are fixed by the upper holding member and the lower holding member, respectively, and a discharging pipe is connected to both of the upper holding member and the lower holding member to collect water from both ends of the hollow-fiber membranes. When water is collected from both ends of the hollow-fiber membranes as described above, in comparison with the case where water is collected from one end, the pipe resistance in the hollow-fiber membranes can be reduced to one-eighth, so that the water-collecting efficiency can be increased. When water is collected from both ends, it is desirable to employ the following system: First, the lower holding member is designed to have a shape illustrated by the plan view shown in FIG. 2a. Multiple fixing parts 6b are each provided at their inside with a water-collecting pass. Water is collected by using a discharging pipe placed at the side face of the lower holding member 6. By using this system, a space that enables the passing of gas bubbles can be provided at the lower portion in the lower holding member. Consequently, as with the above-described embodiments, a gas bubble supplied by the gas supplier can be divided by the fixing parts and the divided gas bubbles can be fed to the hollow-fiber membranes effectively.

The direction by which the hollow-fiber membranes of the filtration module are aligned by being pulled is not limited to the upward-downward direction. It can be a horizontal direction or a slanting direction. Even when the hollow-fiber membranes are aligned by being pulled in such a direction, because each of the gas bubbles supplied from under is divided at a position between hollow-fiber membranes, the effect of the present invention can be exerted.

### EXAMPLES

The present invention is explained in further detail below by showing examples. However, the present invention is not limited by those examples.

### Example 1

By using a filtration apparatus provided with a filtration module, a gas supplier, and a guide cover shown in FIGS. 3a and 3b, a treatment-undergoing liquid (sludge) was filtration treated at a treating rate of 0.7 m³/m²·day. A variation was measured in the pressure difference between the inside and outside of the hollow-fiber membranes. The hollow-fiber membranes had an average length of 3.2 m, an average outer diameter of 2.3 mm, and an average inner diameter of 1.1 mm. The number of hollow-fiber membranes was 740. The guide cover had a length of 3.7 m. This length enabled to cover all of the hollow-fiber membranes, upper holding member, and lower holding member in the upward-downward direction. The filtration treatment was performed by using an intermittent gas-bubble injection-type gas diffuser (an intermittent pump). The gas bubbles were supplied intermittently at a supplying rate of 50 L/min so that the gas bubbles were able to be divided at the lower holding member. The treatment was performed such that nine-minute operation and one-minute nonoperation were repeated. The measured result is shown in FIG. 6.

### Example 2

This example used the same filtration module as used in Example 1 except that the two ends of the multiple hollow-fiber membranes were fixed by the upper holding member and the lower holding member, respectively, and a discharging, pipe was connected to both of the upper holding member and the lower holding member to collect water from both ends of the hollow-fiber membranes. Gas bubbles were supplied intermittently at the same supplying rate as used in Example 1. A variation was measured in the pressure difference between the inside and outside of the hollow-fiber membranes. A pair of intermittent pumps (two pumps) were placed at center-of-mass symmetrical positions at the side of the lower holding member such that the lower holding member was sandwiched between them. This configuration caused the gas bubbles to be divided by multiple hollow-fiber membranes, not by the lower holding member. The measured result is shown in FIG. 7.

### Comparative Example 1

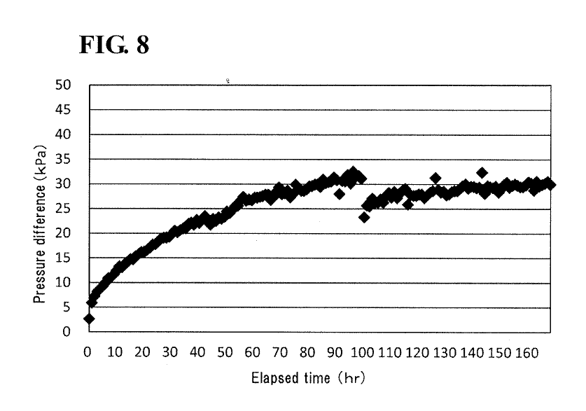

A filtration treatment was performed under the same condition as employed in Example 1 except that a gas diffuser using a perforated pipe was used and gas bubbles not to be divided by the lower holding member were continuously supplied by the diffuser at the same supplying rate as used in Example 1. A variation was measured in the pressure difference between the inside and outside of the hollow-fiber membranes. The measured result is shown in FIG. 8.

As can be seen by comparing the FIG. 6 and FIG. 8, the filtration apparatus in Example 1 can noticeably decrease the pressure difference in comparison with the filtration apparatus in Comparative example 1. This is attributable to the fact that the gas bubbles divided by the lower holding member uniformly spread between the hollow-fiber membranes. In addition, as shown in FIG. 7, the filtration module designed as a both-end water collection type, also, can achieve the same effect as that obtained by a one-end water collection type.

### INDUSTRIAL APPLICABILITY

As described above, the filtration apparatus and immersion-type filtration method of the present invention have an excellent capability to clean the surface of hollow-fiber membranes and can maintain their high filtration capability. Consequently, the filtration apparatus can be used advantageously in various fields as a solid-liquid separation treatment apparatus.

### REFERENCE SIGNS LIST

1 and 11: Filtration apparatus
2: Filtration module
3: Gas supplier
4: Hollow-fiber membrane
5: Upper holding member
6 and 16: Lower holding member
6a: Outer frame
6b and 16b: Fixing part
7: Discharging pipe
8: Guide cover

1. A filtration apparatus, being an immersion type and comprising:
a filtration module having multiple hollow-fiber membranes held in a state in which they are arranged by being pulled unidirectionally; and
a gas supplier that supplies gas bubbles from under the filtration module;
wherein each of the gas bubbles supplied by the gas supplier is divided into a plurality of gas bubbles after colliding against the filtration module.

2. The filtration apparatus as defined by claim 1, wherein the gas bubbles supplied by the gas supplier have an average horizontal diameter larger than the maximum spacing of holding portions in the multiple hollow-fiber membranes in the filtration module.

3. The filtration apparatus as defined by claim 1, wherein:
the filtration module comprises an upper holding member and a lower holding member both for positioning the multiple hollow-fiber membranes in the upward-downward direction;
the upper holding member communicates with upper openings of the multiple hollow-fiber membranes and has an outlet that collects filtrated liquids; and
the gas supplier is located at a position under the lower holding member.

4. The filtration apparatus as defined by claim 3, further comprising a guide cover that surrounds at least an upper portion of the multiple hollow-fiber membranes.

5. An immersion-type filtration method, using the filtration apparatus as defined by claim 1.
